(19) United States
(12) Patent Application Publication
(10) Pub. No.: US 2026/0255379 A1
(43) Pub. Date: Aug. 27, 2026

(54) Methods And Apparatus For Avoiding Measurement Object Configuration Overlapping With RF Interference

(71) Applicant: MediaTek Inc., Hsinchu City (TW)

(72) Inventors: Yi-Ming You, Hsinchu City (TW); Waseem Hazim Ozan Ozan, Cambridge (GB); Huan-Ren Fu, Hsinchu City (TW); Ming-Yu Hsieh, Hsinchu City (TW); Shih-Hsi Hu, Hsinchu City (TW); Tsang-Wei Yu, Hsinchu City (TW)

(73) Assignee: MediaTek Inc., Hsinchu City (TW)

(21) Appl. No.: 19/534,615

(22) Filed: Feb. 9, 2026

Related U.S. Application Data
(60) Provisional application No. 63/762,690, filed on Feb. 25, 2025.

(51) Int. Cl. H04W 72/541; H04W 24/10; H04W 72/231; H04L 5/00

(52) U.S. Cl. CPC H04W 72/541; H04W 24/10; H04W 72/231; H04L 5/0035; H04L 5/0098

(57) ABSTRACT

Various solutions for avoiding measurement object configuration overlapping with radio frequency (RF) interference are described. A network node may determine whether a reference signal in a measurement object (MO) is affected by radio frequency (RF) interference. The network node may configure or reconfigure the reference signal to a user equipment (UE) in an event that the reference signal in the MO is not affected by the RF interference. The network node may determine not to configure the reference signal to the UE in an event that the reference signal in the MO is affected by the RF interference.

### CROSS REFERENCE TO RELATED PATENT APPLICATION(S)

The present disclosure is part of a non-provisional application claiming the priority benefit of U.S. Application No. 63/762,690, filed 25 February 2025, the content of which herein being incorporated by reference in its entirety.

### TECHNICAL FIELD

The present disclosure is generally related to wireless communications and, more particularly, to a method and apparatus for avoiding measurement object configuration overlapping with radio frequency (RF) interference.

### BACKGROUND

Unless otherwise indicated herein, approaches described in this section are not prior art to the claims listed below and are not admitted as prior art by inclusion in this section.

In cellular communication systems such as fifth-generation (5G) New Radio (NR) and future sixth-generation (6G) systems, user equipment (UE) may perform various types of radio measurements for mobility management and network optimization. Such measurements may be performed in a gap-assisted manner, in a non-gap-assisted manner, or in an interruption-based manner. Whether a measurement gap is required in NR depends on several factors, including the UE’s capability, the UE’s currently active bandwidth part (BWP), and the operating frequency of a serving cell.

In current NR systems, the UE may report measurement gap configuration and/or interruption requirement information for a target frequency band in response to a network (NW) configured radio resource control (RRC) message. The reported information may be provided per target band to indicate whether the UE requires a measurement gap or interruption to perform accurate measurements.

However, in certain scenarios, radio frequency (RF) harmonics or intermodulation products generated by the UE’s uplink (UL) transmission may fall within a target downlink (DL) band. Such interference may occur regardless of whether the target synchronization signal block (SSB) itself is directly affected. This condition may cause self-interference from UL to DL, resulting in degraded receiver performance.

When the reference signals configured in a measurement object (MO) are not included in any supported carrier aggregation (CA) or dual connectivity (DC) band combinations, potential self-interference from UL transmissions may cause significant RF desensitization in the target band being measured. As a result, the UE may not be able to provide reliable or accurate measurement results.

Measurement objects subject to RF desensitization conditions often require gap-assisted, interruption-based, or scheduling-restricted measurements. These measurement restrictions may negatively impact overall system throughput and degrade user experience. Therefore, the network should avoid configuring measurement objects that are known to be associated with RF desensitization issues for a given UE, thereby reducing the number of interruptions required during measurement operations.

For example, FIG. 1 illustrates a scenario in which the target band overlaps with RF harmonic products generated from the UE’s uplink transmission. As shown, when the UE transmits in Band n3 NR, the corresponding RF harmonic products (e.g., 2×fₓ, 3×fₓ, 4×fₓ, 5×fₓ) may fall within the frequency ranges of other NR bands such as Band n77 or Band n46. In this case, the SSB of Band n77 or Band n46 may overlap with the RF harmonic products of the UL signal, as indicated by the black bars. The overlapping regions may cause RF desensitization in the target bands, resulting in measurement inaccuracy.

Therefore, a solution is needed to avoid measurement object configuration overlapping with RF interference.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to avoiding measurement object configuration overlapping with RF interference.

In one aspect, a method may involve an apparatus determining whether a reference signal in a measurement object (MO) is affected by radio frequency (RF) interference. The method may also involve the apparatus configuring or reconfiguring the reference signal to a user equipment (UE) in an event that the reference signal in the MO is not affected by the RF interference.

In another aspect, an apparatus may comprise a transceiver which, during operation, wirelessly communicates with a network. The apparatus may also comprise a processor communicatively coupled to the transceiver. The processor, during operation, may perform operations comprising determining whether a reference signal in an MO is affected by RF interference. The processor, during operation, may also perform operations comprising configuring or reconfiguring the reference signal to a UE in an event that the reference signal in the MO is not affected by the RF interference.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 illustrates a scenario in which the target bands overlap with RF harmonic products generated from the UE’s uplink transmission.

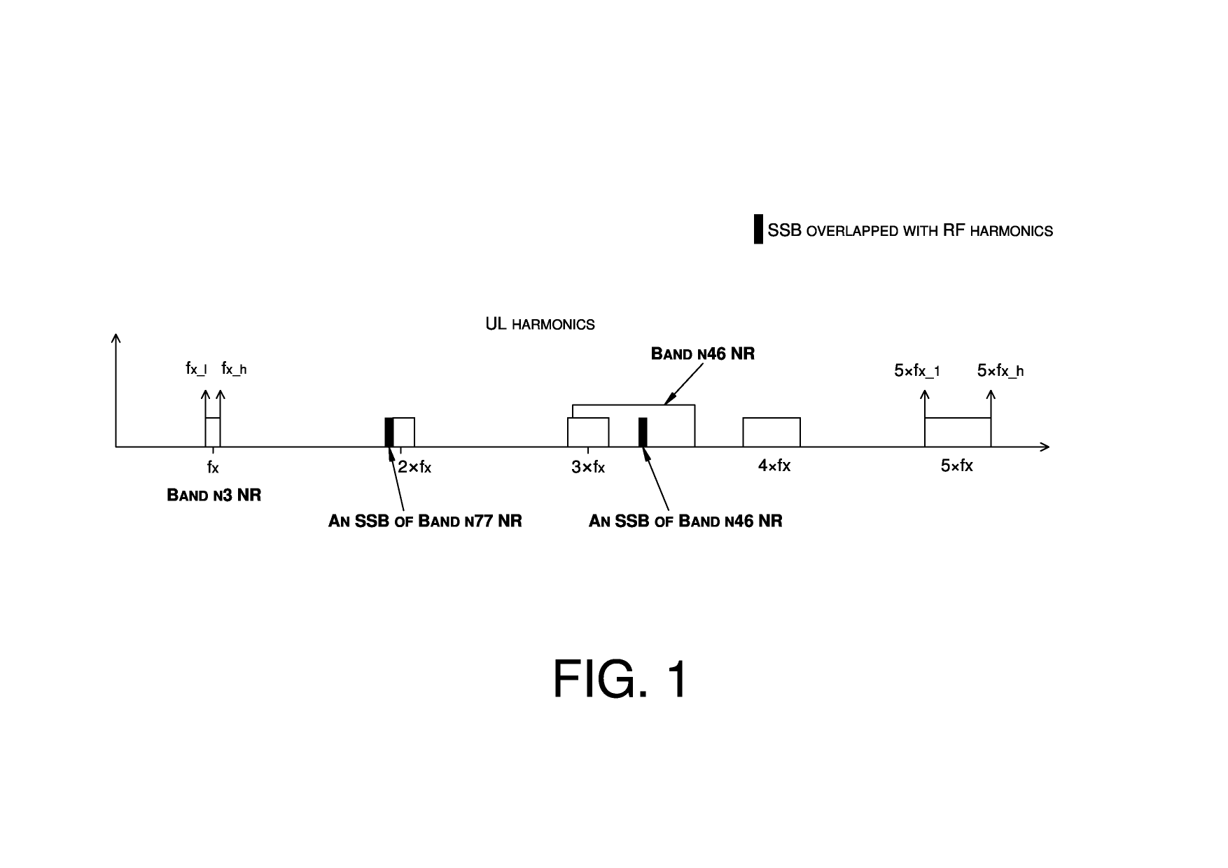

FIG. 2 illustrates an example of a wireless communications system in accordance with aspects of the present disclosure.

FIG. 3 illustrates an example of a process that supports methods for avoiding measurement object configuration overlapping with RF interference in accordance with aspects of the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to avoiding measurement object configuration overlapping with RF interference. According to the present disclosure, a number of possible solutions may be implemented separately or jointly. That is, although these possible solutions may be described below separately, two or more of these possible solutions may be implemented in one combination or another.

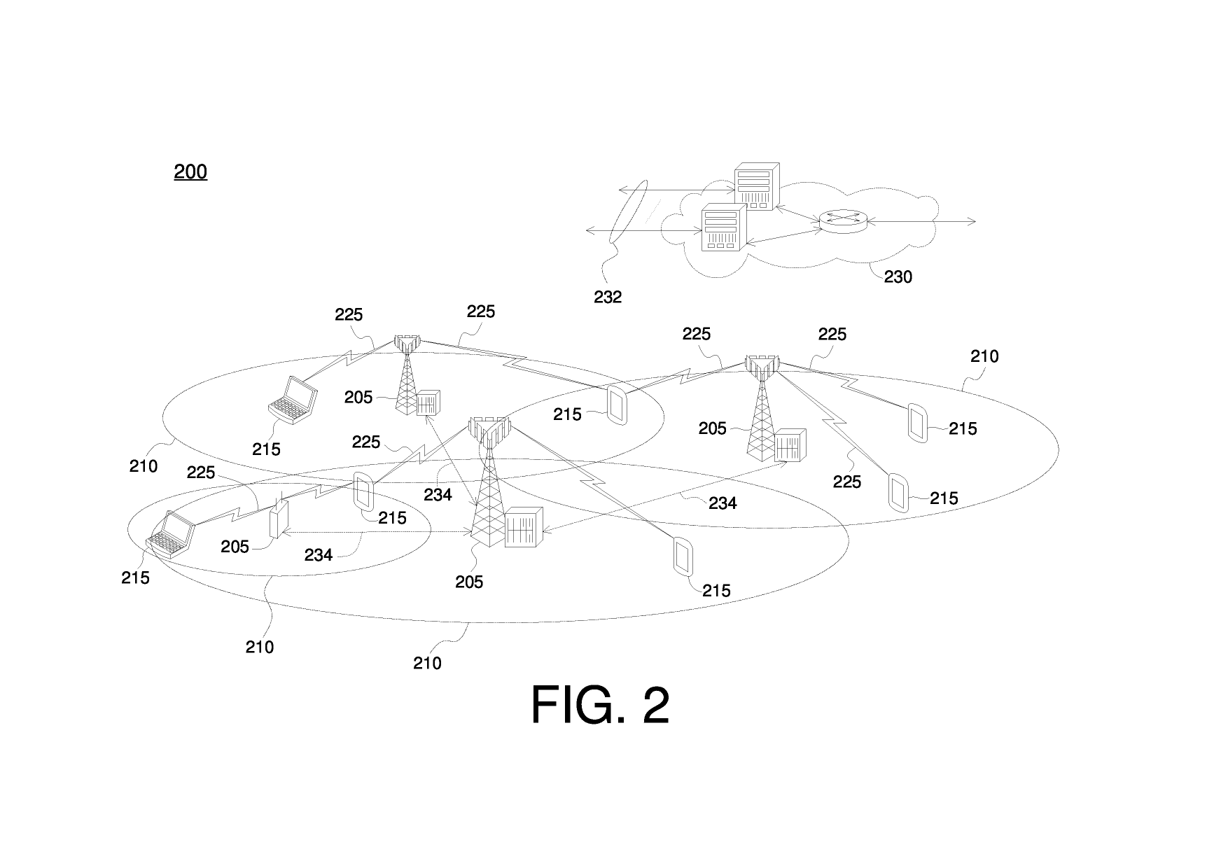

FIG. 2 illustrates an example of a wireless communications system 200 in accordance with aspects of the present disclosure. The wireless communications system 200 includes base stations 205, UEs 215, and a core network 230. In some examples, the wireless communications system 200 may be a Long-Term Evolution (LTE) network, an LTE-Advanced (LTE-A) network, a 5G network, or a 6G new radio (NR) network. In some cases, wireless communications system 200 may support enhanced broadband communications, ultra-reliable (e.g., mission-critical) communications, low latency communications, or communications with low-cost and low-complexity devices.

Base stations 205 may wirelessly communicate with UEs 215 via one or more base station antennas. Base stations 205 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 200 may include base stations 205 of different types (e.g., macro or small cell base stations). The UEs 215 described herein may be able to communicate with various types of base stations 205 and network equipment, including macro eNBs, small cell eNBs, gNBs, relay base stations, and the like.

Each base station 205 may be associated with a particular geographic coverage area 210 in which communications with various UEs 215 are supported. Each base station 205 may provide communication coverage for a respective geographic coverage area 210 via communication links 225, and communication links 225 between a base station 205 and a UE 215 may utilize one or more carriers. Communication links 225 shown in wireless communications system 200 may include uplink transmissions from a UE 215 to a base station 205, or downlink transmissions from a base station 205 to a UE 215. Downlink transmissions may also be called forward link transmissions, while uplink transmissions may also be called reverse link transmissions.

The geographic coverage area 210 for a base station 205 may be divided into sectors making up only a portion of the geographic coverage area 210, and each sector may be associated with a cell. For example, each base station 205 may provide communication coverage for a macro cell, a small cell, a hot spot, or other types of cells, or various combinations thereof. In some examples, a base station 205 may be movable and therefore provide communication coverage for a moving geographic coverage area 210. In some examples, different geographic coverage areas 210 associated with different technologies may overlap, and overlapping geographic coverage areas 210 associated with different technologies may be supported by the same base station 205 or by different base stations 205. The wireless communications system 200 may include, for example, a heterogeneous LTE/LTE-A, 5G, or 6G NR network in which different types of base stations 205 provide coverage for various geographic coverage areas 210.

The term “cell” refers to a logical communication entity used for communication with a base station 205 (e.g., over a carrier) and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 210 (e.g., a sector) over which the logical entity operates.

UEs 215 may be dispersed throughout the wireless communications system 200, and each UE 215 may be stationary or mobile. A UE 215 may also be referred to as a mobile device, a wireless device, a remote device, a handheld device, or a subscriber device, or some other suitable terminology, where the “device” may also be referred to as a unit, a station, a terminal, or a client. A UE 215 may also be a personal electronic device such as a cellular phone, a personal digital assistant (PDA), a tablet computer, a laptop computer, or a personal computer. In some examples, a UE 215 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Base stations 205 may communicate with the core network 230 and with one another. For example, base stations 205 may interface with the core network 230 through backhaul links 232 (e.g., via an S1, N2, N3, or other interface). Base stations 205 may communicate with one another over backhaul links 234 (e.g., via an X2, Xn, or other interface) either directly (e.g., directly between base stations 205) or indirectly (e.g., via core network 230).

The core network 230 may provide user authentication, access authorization, tracking, Internet Protocol (IP) connectivity, and other access, routing, or mobility functions. The core network 230 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 215 served by base stations 205 associated with the EPC. User IP packets may be transferred through the S-GW, which itself may be connected to the P-GW. The P-GW may provide IP address allocation as well as other functions. The P-GW may be connected to the network operators' IP services. The operator's IP services may include access to the Internet, Intranet(s), an IP Multimedia Subsystem (IMS), or a Packet-Switched (PS) Streaming Service.

At least some of the network devices, such as a base station 205, may include subcomponents such as an access network entity, which may be an example of an access node controller (ANC). Each access network entity may communicate with UEs 215 through a number of other access network transmission entities, which may be referred to as a radio head, a smart radio head, or a transmission/reception point (TRP). In some configurations, various functions of each access network entity or base station 205 may be distributed across various network devices (e.g., radio heads and access network controllers) or consolidated into a single network device (e.g., a base station 205).

In wireless communications system 200, base station 205 or UE 215 may be equipped with multiple antennas, which may be used to employ techniques such as transmit diversity, receive diversity, multiple-input multiple-output (MIMO) communications, or beamforming. For example, wireless communications system 200 may use a transmission scheme between a transmitting device (e.g., a base station 205) and a receiving device (e.g., a UE 215), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing.

The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Wireless communications system 200 may support efficient techniques for avoiding measurement object (MO) configuration overlapping with RF interference. In some cases, the base station 205 may determine whether a reference signal in a measurement object is affected by the RF interference to determine whether to configure or not to configure the reference signal to the UE 215. Specifically, the base station 205 may determine whether the reference signal and frequency bands configured to the UE overlap with RF harmonics or intermodulation products of uplink (UL) or downlink (DL) bands. The frequency bands configured to the UE may comprise at least one of carrier aggregation (CA) bands, dual connectivity (DC) bands, supplementary UL or DL bands, and activated or deactivated bands for a secondary cell (SCell) or a primary secondary cell (PSCell).

Additionally or alternatively, the base station 205 may reconfigure an interruption, a measurement gap, or a scheduling restriction to the UE 215 in an event that the reference signal in the MO is affected by the RF interference.

In some embodiments, the reference signal is configured to the UE 215 for measurement via a radio resource control (RRC) signaling (e.g., RRC reconfiguration message), a downlink control information (DCI), or a medium access control control element (MAC-CE) transmitted by the base station 205. This allows the base station 205 to dynamically update the reference signal configuration according to network conditions, UE capabilities, or measurement requirements.

In some embodiments, the reference signal configured to the UE 215 for measurement may be included in an MO that is configured by the base station 205.

In some embodiments, the MO configured to the UE 215 may include the reference signal used for performing layer 3 (L3) measurements, such as intra-frequency, inter-frequency, or inter-radio access technology (inter-RAT) reference signal received power (RSRP) measurements, for neighboring or serving cells.

In some embodiments, the reference signals configured to the UE 215 may be used for performing layer 1 (L1) measurements, such as radio link monitoring (RLM), beam failure detection (BFD), or L1 RSRP measurements.

In some embodiments, the UE 215 may perform the measurements on serving cells, including a primary cell (PCell), a PSCell, or an SCell, as well as on target neighboring cells, serving transmission reception points (TRPs), and target neighboring TRPs.

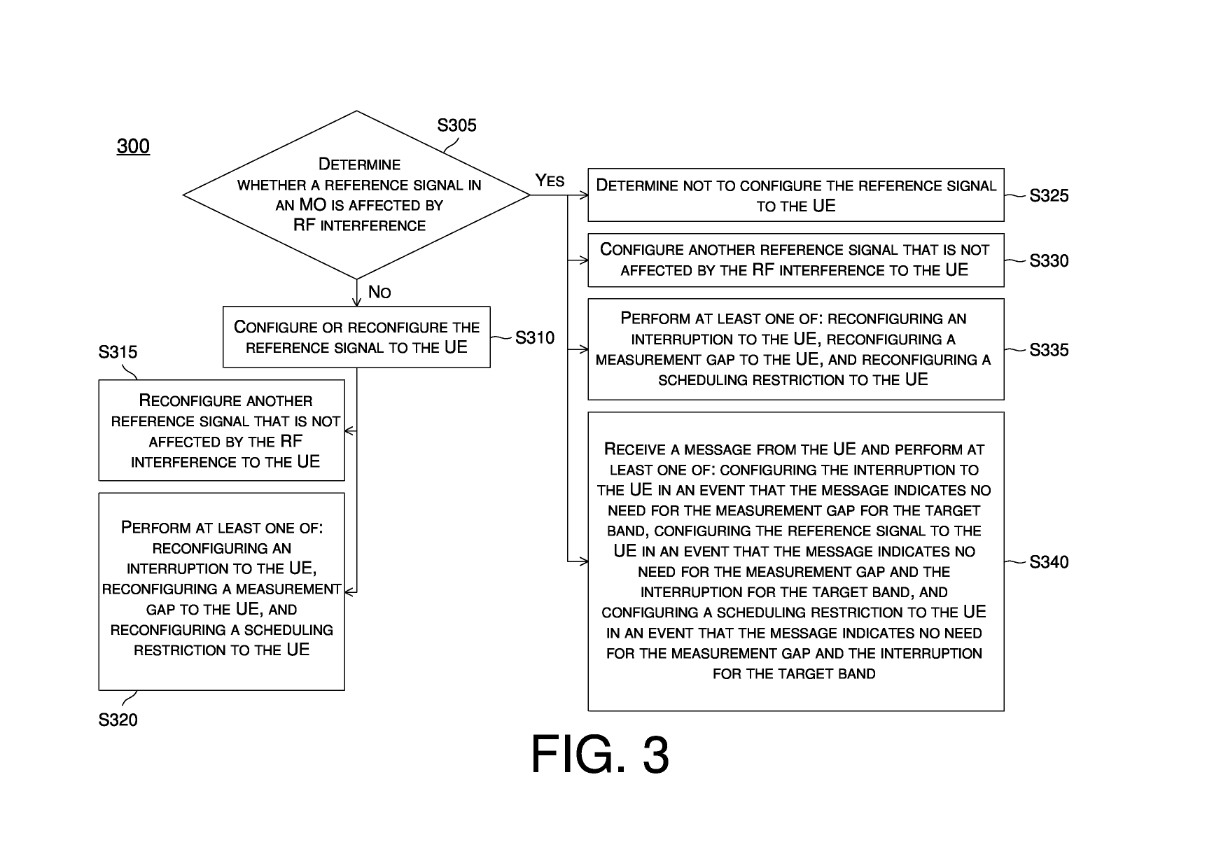

FIG. 3 illustrates an example of a process 300 that supports methods for avoiding measurement object configuration overlapping with RF interference in accordance with aspects of the present disclosure. In some examples, process 300 may implement aspects of wireless communications system 200. Aspects of process 300 may be implemented by a base station, which may be an example of the corresponding devices described herein.

At step S305, the base station may determine whether a reference signal in an MO is affected by RF interference. The reference signal may include, but is not limited to, synchronization signal blocks (SSBs), channel state information reference signals (CSI-RSs), or any other reference signals configured or indicated to the UE for measurement purposes. Specifically, when the base station configures or reconfigures the UE with one or more MOs, and/or with one or more frequency bands for CA and/or DC, the base station may determine whether the reference signal in the MO is affected by RF interference. In particular, the base station may determine whether the reference signal in the MO falls within the frequency regions where RF harmonics or intermodulation distortion (IMD) products of the UE occur. This determination may be made by determining whether the reference signal and frequency bands configured to the UE overlap with any of the RF harmonics or intermodulation products that may be generated by the UE’s UL and/or DL transmissions. Since the RF harmonics, IMD, or harmonic mixing products that may cause desensitization are typically generated at the UE based on the frequency bands configured to the UE, i.e., the UE’s operating bands, the base station may determine whether any of the reference signals in the MO are subject to potential RF desensitization due to RF harmonics or intermodulation products.

In one embodiment, the base station may determine whether the reference signal in the MO is affected by the RF interference based on the scheduled DL and/or UL bands, namely, by checking whether the frequencies of the scheduled transmission or reception bandwidths overlap with the RF harmonics or IMD products. In another embodiment, the base station may determine whether the reference signal in the MO is affected by the RF interference based on the bandwidth (BW) of the currently operating bandwidth part (BWP) configured to the UE. By checking the frequency range of the operating BWP, the base station may identify potential RF harmonics or IMD products that may cause self-interference or desensitization to the reference signals in the MO.

In an event that the reference signal in the MO is not affected by the RF interference (“No” at step S305), at step S310, the base station configures or reconfigures the reference signal to the UE.

In one embodiment, after step S310, in an event that the base station receives a message from the UE and the message indicates that the reference signal is affected by the RF interference, one or more subsequent steps, such as S315 or S320, may be executed. In another embodiment, the message received from the UE may include UE assistance information (UAI) or any other form of signaling that indicates the reference signal is affected by the RF interference. As one example, at step S315, the base station may reconfigure another reference signal that is not affected by the RF interference to the UE.

As another example, at step S320, the base station may perform at least one of reconfiguring an interruption to the UE, reconfiguring a measurement gap to the UE, and reconfiguring a scheduling restriction to the UE. Such reconfiguration enables the UE to perform accurate measurements on the affected reference signals while mitigating the impact of RF interference or harmonic distortion. In one embodiment, the base station reconfigures a scheduling restriction such that the UE is not expected to transmit Physical Uplink Control Channel (PUCCH), Physical Uplink Shared Channel (PUSCH), or Sounding Reference Signal (SRS) on the symbols corresponding to the reference signals to be measured. In addition, the UE is not expected to transmit PUCCH, PUSCH, or SRS on one data symbol before and one data symbol after each consecutive reference signal symbol to be measured. This reconfiguration may minimize uplink interference during the measurement operation. In another embodiment, the measurement gap or interruption is applied to one or more UL frequency bands, allowing the UE to suspend UL transmissions in the affected frequency range during the measurement operation. In still another embodiment, the measurement gap or interruption is applied to one or more UL and/or DL frequency bands. This allows greater flexibility for the base station to ensure reliable measurements under varying RF interference conditions.

In an event that the base station determines that the reference signal in the MO is affected by the RF interference (“Yes” at step S305), the base station may proceed with different operations, such as those illustrated in steps S325, S330, S335, and S340. As one example, at step S325, the base station may determine not to configure the reference signal to the UE. As another example, at step S330, the base station may configure another reference signal that is not affected by the RF interference to the UE.

As yet another example, at step S335, the base station may perform at least one of reconfiguring an interruption to the UE, reconfiguring a measurement gap to the UE, and reconfiguring a scheduling restriction to the UE. Such reconfiguration enables the UE to perform accurate measurements on the affected reference signals while mitigating the impact of RF interference or harmonic distortion. In one embodiment, the base station reconfigures a scheduling restriction such that the UE is not expected to transmit Physical Uplink Control Channel (PUCCH), Physical Uplink Shared Channel (PUSCH), or SRS on the symbols corresponding to the reference signals to be measured. In addition, the UE is not expected to transmit PUCCH, PUSCH, or SRS on one data symbol before and one data symbol after each consecutive reference signal symbol to be measured. This reconfiguration may minimize uplink interference during the measurement operation. In another embodiment, the measurement gap or interruption is applied to one or more UL frequency bands, allowing the UE to suspend UL transmissions in the affected frequency range during the measurement operation. In still another embodiment, the measurement gap or interruption is applied to one or more UL and/or DL frequency bands. This allows greater flexibility for the base station to ensure reliable measurements under varying RF interference conditions.

As another option, at S340, the base station may receive a message from the UE, and the message indicates no need for a measurement gap or an interruption for a target band. The base station may perform at least one of configuring the interruption to the UE in an event that the message indicates no need for the measurement gap for the target band, configuring the reference signal to the UE in an event that the message indicates no need for the measurement gap and the interruption for the target band, and configuring a scheduling restriction to the UE in an event that the message indicates no need for the measurement gap and the interruption for the target band. Such a configuration may allow the UE to continue operation without measurement gaps while still maintaining acceptable measurement performance under the identified RF interference conditions.

### Illustrative Implementations

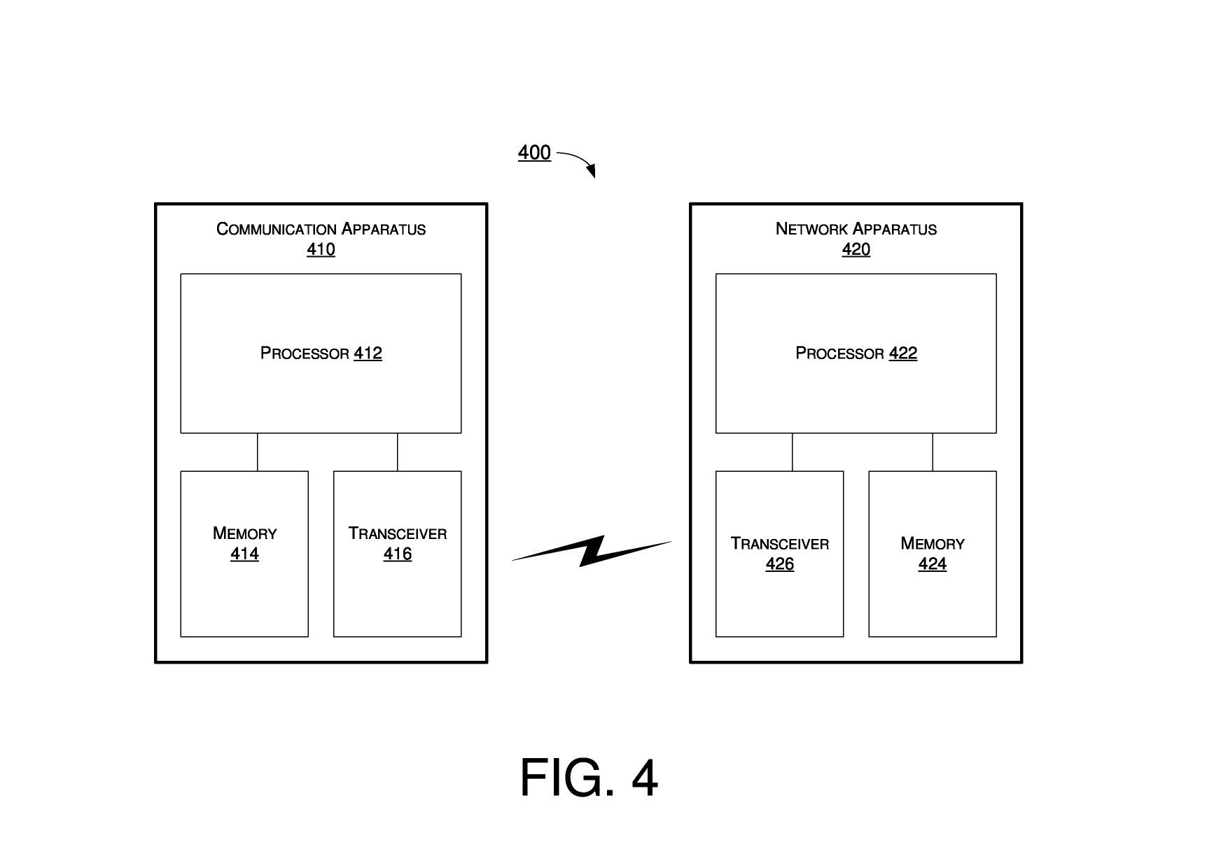

FIG. 4 illustrates an example communication system 400 having at least an example communication apparatus 410 and an example network apparatus 420 in accordance with an implementation of the present disclosure. Each of the communication apparatus 410 and network apparatus 420 may perform various functions to implement schemes, techniques, processes, and methods described herein of avoiding measurement object configuration overlapping with RF interference, including scenarios/schemes described above, as well as process 500 described below.

Communication apparatus 410 may be a part of an electronic apparatus, which may be a UE such as a portable or mobile apparatus, a wearable apparatus, a wireless communication apparatus, or a computing apparatus. For instance, communication apparatus 410 may be implemented in a smartphone, a smartwatch, a personal digital assistant, a digital camera, or a computing equipment such as a tablet computer, a laptop computer, or a notebook computer. Communication apparatus 410 may also be a part of a machine type apparatus, which may be an IoT, NB-IoT, or IIoT apparatus, such as an immobile or a stationary apparatus, a home apparatus, a wire communication apparatus, or a computing apparatus. For instance, communication apparatus 410 may be implemented in a smart thermostat, a smart fridge, a smart door lock, a wireless speaker, or a home control center. Alternatively, communication apparatus 410 may be implemented in the form of one or more integrated-circuit (IC) chips, such as, for example, and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4, such as a processor 412, for example. Communication apparatus 410 may further include one or more other components not pertinent to the proposed scheme of the present disclosure (e.g., internal power supply, display device, and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router, or a gateway. For instance, network apparatus 420 may be implemented in an eNB in an LTE network, in a gNB in a 5G/NR, IoT, NB-IoT or IIoT network, or in a satellite or base station in a 6G network. Network apparatus 420 may include at least some of those components shown in FIG. 4, such as a processor 422, for example. Processor 422 may further include protocol stacks and a set of control functional modules and circuits. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of the processor 412 and processor 422 may be implemented in the form of one or more single-core processors, one or more multi-core processors, or one or more CISC processors. That is, even though a singular term “a processor” is used herein to refer to processor 412 and processor 422, each of the processor 412 and processor 422 may include multiple processors in some implementations and a single processor in other implementations in accordance with the present disclosure. In another aspect, each of the processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and processor 422 is a special-purpose machine specifically designed, arranged, and configured to perform specific tasks in a device (e.g., as represented by communication apparatus 410) and a network (e.g., as represented by network apparatus 420) in accordance with various implementations of the present disclosure.

In some implementations, communication apparatus 410 may also include a memory 414 coupled to processor 412 and capable of being accessed by processor 412 and storing data therein. In some implementations, communication apparatus 410 may further include a transceiver 416 coupled to processor 412 and capable of wirelessly transmitting and receiving data.

In some implementations, network apparatus 420 may further include a memory 424 coupled to processor 422 and capable of being accessed by processor 422 and storing data therein, and a transceiver 426 coupled to processor 422 and capable of wirelessly transmitting and receiving data. Accordingly, communication apparatus 410 and network apparatus 420 may wirelessly communicate with each other via transceiver 416 and transceiver 426, respectively.

For illustrative purposes and without limitation, descriptions of capabilities of the communication apparatus 410 and network apparatus 420 are provided below with process 500. In which, communication apparatus 410 is implemented in or as a communication apparatus or a UE, and network apparatus 420 is implemented in or as a network node of a communication network (e.g., a base station).

### Illustrative Processes

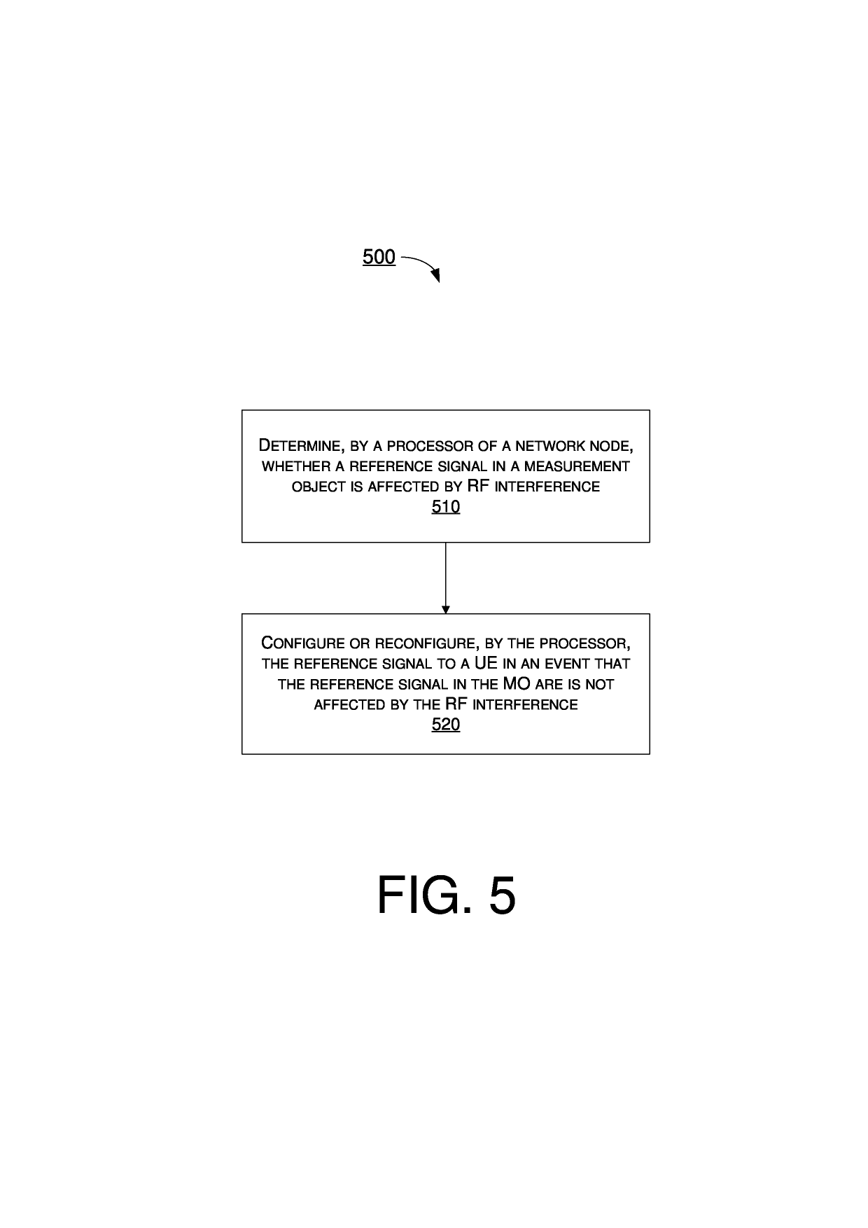

FIG. 5 illustrates an example process 500 in accordance with an implementation of the present disclosure. Process 500 may be an example implementation of the above scenarios/schemes, whether partially or completely, with respect to avoiding measurement object configuration overlapping with RF interferences. Process 500 may represent an aspect of the implementation of features of network apparatus 420. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 420 or any suitable network entity in the 4G, 5G, or 6G network (e.g., base station 205). Solely for illustrative purposes and without limitation, process 500 is described below in the context of network apparatus 420 as a base station. Process 500 may begin at block 510.

At block 510, process 500 may involve processor 422 of determining whether a reference signal in a measurement object (MO) is affected by radio frequency (RF). Process 500 may proceed from block 510 to block 520.

At block 520, process 500 may involve processor 422 configuring or reconfiguring the reference signal to a UE (e.g., communication apparatus 410) in an event that the reference signal in the MO is not affected by the RF interference.

In some implementations, process 500 may involve processor 422 determining not to configure the reference signal to the UE in an event that the reference signal in the MO is affected by the RF interference.

In some implementations, process 500 may involve processor 422 configuring another reference signal that is not affected by the RF interference to the UE in an event that the reference signal in the MO is affected by the RF interference.

In some implementations, in an event that the reference signal in the MO is affected by the RF interference, process 500 may involve processor 422 performing at least one of: reconfiguring an interruption to the UE, reconfiguring a measurement gap to the UE, and reconfiguring a scheduling restriction to the UE.

In some implementations, in an event that the reference signal in the MO is affected by the RF interference, process 500 may involve processor 422 receiving, via transceiver 426, a message from the UE. The message indicates no need for a measurement gap or an interruption for a target band. Process 500 may involve processor 422 performing, according to the message, one of: configuring the interruption to the UE in an event that the message indicates no need for the measurement gap for the target band, configuring the reference signal to the UE in an event that the message indicates no need for the measurement gap and the interruption for the target band, and configuring a scheduling restriction to the UE in an event that the message indicates no need for the measurement gap and the interruption for the target band.

In some implementations, process 500 may involve processor 422 receiving, via transceiver 426, a message from the UE. The message indicates that the reference signal is affected by the RF interference. Process 500 may involve processor 422 reconfiguring another reference signal that is not affected by the RF interference to the UE.

In some implementations, process 500 may involve processor 422 receiving, via transceiver 426, a message from the UE. The message indicates that the reference signal is affected by the RF interference. Process 500 may involve processor 422 performing at least one of: reconfiguring an interruption to the UE, reconfiguring a measurement gap to the UE, and reconfiguring a scheduling restriction to the UE.

In some implementations, process 500 may involve processor 422 determining whether the reference signal and frequency bands configured to the UE overlap with RF harmonics or intermodulation products of UL or DL bands.

In some implementations, the frequency bands configured to the UE comprise at least one of CA bands, DC bands, supplementary UL or DL bands, and activated or deactivated bands for an SCell or a PSCell.

In some implementations, the reference signal is configured to the UE via an RRC signaling.

### Additional Notes

The herein-described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a network node, whether a reference signal in a measurement object (MO) is affected by radio frequency (RF) interference; and
configuring or reconfiguring, by the processor, the reference signal to a user equipment (UE) in an event that the reference signal in the MO is not affected by the RF interference.

2. The method of claim 1, further comprising:
determining, by the processor, not to configure the reference signal to the UE in an event that the reference signal in the MO is affected by the RF interference.

3. The method of claim 1, further comprising:
configuring, by the processor, another reference signal that is not affected by the RF interference to the UE in an event that the reference signal in the MO is affected by the RF interference.

4. The method of claim 1, wherein, in an event that the reference signal in the MO is affected by the RF interference, the method further comprises:
performing, by the processor, at least one of:
reconfiguring an interruption to the UE;
reconfiguring a measurement gap to the UE; and
reconfiguring a scheduling restriction to the UE.

5. The method of claim 1, wherein in an event that the reference signal in the MO is affected by the RF interference, the method further comprises:
receiving, by the processor, a message from the UE, wherein the message indicates no need for a measurement gap or an interruption for a target band; and
performing, by the processor according to the message, one of:
configuring the interruption to the UE in an event that the message indicates no need for the measurement gap for the target band;
configuring the reference signal to the UE in an event that the message indicates no need for the measurement gap and the interruption for the target band; and
configuring a scheduling restriction to the UE in an event that the message indicates no need for the measurement gap and the interruption for the target band.

6. The method of claim 1, further comprising:
receiving, by the processor, a message from the UE, wherein the message indicates that the reference signal is affected by the RF interference; and
reconfiguring, by the processor, another reference signal that is not affected by the RF interference to the UE.

7. The method of claim 1, further comprising:
receiving, by the processor, a message from the UE, wherein the message indicates that the reference signal is affected by the RF interference; and
performing, by the processor, at least one of:
reconfiguring an interruption to the UE;
reconfiguring a measurement gap to the UE; and
reconfiguring a scheduling restriction to the UE.

8. The method of claim 1, wherein the determining of whether the reference signal in the MO is affected by the RF interference further comprises:
determining whether the reference signal and frequency bands configured to the UE overlap with RF harmonics or intermodulation products of uplink (UL) or downlink (DL) bands.

9. The method of claim 8, wherein the frequency bands configured to the UE comprise at least one of carrier aggregation (CA) bands, dual connectivity (DC) bands, supplementary UL or DL bands, and activated or deactivated bands for a secondary cell (SCell) or a primary secondary cell (PSCell).

10. The method of claim 1, wherein the reference signal is configured to the UE via a radio resource control (RRC) signaling.

11. An apparatus, comprising:
a transceiver which, during operation, communicates wirelessly; and
a processor communicatively coupled to the transceiver such that, during operation, the processor performs operations comprising:
determining whether a reference signal in a measurement object (MO) is affected by radio frequency (RF) interference; and
configuring or reconfiguring the reference signal to a user equipment (UE) in an event that the reference signal in the MO is not affected by the RF interference.

12. The apparatus of claim 11, wherein the processor is further configured to perform operations comprising:
determining not to configure the reference signal to the UE in an event that the reference signal in the MO is affected by the RF interference.

13. The apparatus of claim 11, wherein the processor is further configured to perform operations comprising:
configuring another reference signal that is not affected by the RF interference to the UE in an event that the reference signal in the MO is affected by the RF interference.

14. The apparatus of claim 11, wherein, in an event that the reference signal in the MO is affected by the RF interference, the processor is further configured to perform operations comprising:
performing at least one of:
reconfiguring an interruption to the UE;
reconfiguring a measurement gap to the UE; and
reconfiguring a scheduling restriction to the UE.

15. The apparatus of claim 11, wherein in an event that the reference signal in the MO is affected by the RF interference, the processor is further configured to perform operations comprising:
receiving, via the transceiver, a message from the UE, wherein the message indicates no need for a measurement gap or an interruption for a target band; and
performing, according to the message, one of:
configuring the interruption to the UE in an event that the message indicates no need for the measurement gap for the target band;
configuring the reference signal to the UE in an event that the message indicates no need for the measurement gap and the interruption for the target band; and
configuring a scheduling restriction to the UE in an event that the message indicates no need for the measurement gap and the interruption for the target band.

16. The apparatus of claim 11, wherein the processor is further configured to perform operations comprising:
receiving, via the transceiver, a message from the UE, wherein the message indicates that the reference signal is affected by the RF interference; and
reconfiguring another reference signal that is not affected by the RF interference to the UE.

17. The apparatus of claim 11, wherein the processor is further configured to perform operations comprising:
receiving, via the transceiver, a message from the UE, wherein the message indicates that the reference signal is affected by the RF interference; and
performing at least one of:
reconfiguring an interruption to the UE;
reconfiguring a measurement gap to the UE; and
reconfiguring a scheduling restriction to the UE.

18. The apparatus of claim 11, wherein, in determining whether the reference signal in the MO is affected by the RF interference, the processor is further configured to perform operations comprising:
determining whether the reference signal and frequency bands configured to the UE overlap with RF harmonics or intermodulation products of uplink (UL) or downlink (DL) bands.

19. The apparatus of claim 18, wherein the frequency bands configured to the UE comprise at least one of carrier aggregation (CA) bands, dual connectivity (DC) bands, supplementary UL or DL bands, and activated or deactivated bands for a secondary cell (SCell) or a primary secondary cell (PSCell).

20. The apparatus of claim 11, wherein the reference signal is configured to the UE via a radio resource control (RRC) signaling.
